(19) United States
(12) Patent Application Publication
(10) Pub. No.: US 2012/0282056 A1
(43) Pub. Date: Nov. 8, 2012

(54) MACHINE TOOL WITH A TOOL CLAMPING DEVICE AND AN ASSOCIATED TOOL

(75) Inventor: Hans ZINDL, Mosbach-Diedesheim (DE)

(73) Assignee: MAG IAS, GMBH, Goppingen (DE)

(21) Appl. No.: 13/463,949

(22) Filed: May 4, 2012

(30) Foreign Application Priority Data
May 6, 2011 (DE) 102011075405.9

(51) Int. Cl. B23C 5/26; B23Q 3/12

(52) U.S. Cl. 409/232; 409/231

(57) ABSTRACT

A tool clamping device for a machine tool has a tool spindle with a first clamping unit, which is coupled to a drive unit. A conventional tool can be clamped and rotatably driven about a rotational axis by means of a first clamping unit. To clamp a heavy tool, a plurality of second clamping units are additionally arranged by means of a housing on the base body of the tool clamping device and about the rotational axis. The heavy tool is clamped by the first clamping unit and the second clamping units and rotatably driven by means of the first clamping unit. For this purpose, the heavy tool has a corresponding first counter-clamping unit and corresponding second counter-clamping units. The tool head of the heavy tool coupled to the first counter-clamping unit and can be rotatably driven by means of the latter.

### CROSS-REFERENCE TO RELATED APPLICATIONS

This application claims the priority of German Patent Application, Serial No. 10 2011 075 405.9, filed May 6, 2011, pursuant to 35 U.S.C. 119(a)-(d), the content of which is incorporated herein by reference in its entirety as if fully set forth herein.

### FIELD OF THE INVENTION

The invention relates to a tool clamping device comprising a base body and a tool spindle arranged on the base body to rotatably drive a tool, with a first clamping unit to clamp the tool and a drive unit coupled to the first clamping unit to rotatably drive the first clamping unit about a rotational axis and a machine tool for machining workpieces using a tool clamping device of this type. The invention also relates to a tool to be received in a tool clamping device according to the invention, comprising a tool base body and a tool head which is arranged on the tool base body, to machine a workpiece.

### BACKGROUND OF THE INVENTION

A tool clamping device is known from DE 199 37 447 A1, in which the tool provided for machining a workpiece is held by a clamping unit arranged in the tool spindle. The clamping unit is arranged at the front end of a connecting rod prestressed by a spring arrangement. The clamping unit contains a plurality of radially movable clamping elements, by means of which the tool is clamped in the tool spindle. To release the tool, the connecting rod is axially displaced by a piston cylinder unit counter to the force of the spring arrangement, so the clamping unit with the clamping elements is opened and releases the tool.

To machine large workpieces, such as, for example, transmission housings for wind turbines, comparatively large and heavy tools are required in comparison to conventional tools. During the machining of the workpiece, these tools also cause comparatively high machining forces, which are to be absorbed by the tool spindle and the clamping unit. The known tool clamping unit is not in a position to do this.

### SUMMARY OF THE INVENTION

The invention is based on an object of developing a tool clamping device of the generic type in such a way that comparatively heavy tools for machining large workpieces can also be clamped.

This object is achieved by a tool clamping device, in which a plurality of second clamping units are arranged on the base body and about the rotational axis of the tool spindle to additionally clamp the tool. The tool clamping device according to the invention, in addition to the conventional first clamping unit, has a plurality of second clamping units, which are arranged on the base body of the tool spindle and about the rotational axis of the tool spindle. A conventional tool can therefore be clamped and rotatably driven in the conventional manner by means of the first clamping unit, whereas a comparatively heavy tool for machining large workpieces can also in addition be clamped by means of the first clamping unit and the second clamping units and its tool head can be rotatably driven by the first clamping unit. The machining forces occurring during workpiece machining with the heavy tool are absorbed, in particular by the second clamping units and the base body, on which the latter are arranged. Tools with a weight up to 50 kg are to be taken to mean a conventional tool here, whereas a heavy tool is to be taken to mean tools having a weight of more than 50 kg, in particular more than 100 kg and, in particular, more than 150 kg. Heavy tools with a weight of, in particular, 1000 kg to 1500 kg can be clamped using the tool clamping device according to the invention. Simple, flexible and efficient machining of large workpieces, such as, for example, transmission housings for wind turbines is made possible using the tool clamping device according to the invention, as both conventional tools and also heavy tools can be used and can be easily exchanged.

A tool clamping device, in which at least three second clamping units and, in particular, at least four second clamping units are arranged on the base body, ensures that heavy tools are reliably received and clamped. Increasingly heavy tools can be clamped with an increasing number of clamping units. The heavy tools, in particular, have a weight of more than 200 kg, in particular, more than 250 kg, and in particular, more than 300 kg.

A tool clamping device, in which the second clamping units are arranged in the form of a polygon, in particular in the form of a rectangle, about the rotational axis, ensures an equally distributed absorption of the machining forces by means of the second clamping units and a correspondingly equally distributed introduction of the machining forces into the base body.

A tool clamping device, in which the second clamping units are stationary relative to the base body, ensures a simple and robust arrangement of the second clamping units on the base body, so that high machining forces can be absorbed. The tool head of a heavy tool, despite the rigid arrangement of the second clamping units, can be rotatably driven by the first clamping unit.

A tool clamping device, in which the second clamping units are axially offset with respect to the first clamping unit, ensures simple and reliable clamping of heavy tools.

A tool clamping device, in which the second clamping units are integrated in a housing, which is fastened to the base body and has a through-opening for the tool spindle, allows easy assembly of second clamping units.

A tool clamping device, in which a coolant connection is arranged laterally next to the tool spindle on the base body, the coolant connection in particular being integrated in the housing, allows coolant to be supplied to the clamped heavy tool. The coolant connection is preferably integrated in the housing so said connection can be easily assembled.

A tool clamping device, in which an electrical connection is arranged laterally next to the tool spindle on the base body, the electrical connection in particular being integrated in the housing, allows the operation of heavy tools, which realize an additional function by means of an electric drive motor. For example, an adjustment of the tool head can be realized by means of the electric drive motor. The electrical connection is preferably integrated in the housing so that said connection can be easily assembled.

A tool clamping device, in which an identification element for tool identification is arranged laterally next to the tool spindle on the base body, the identification element in particular being integrated in the housing, easily allows tool identification in the case of heavy tools. The identification element is preferably integrated in the housing so said identification element can be easily assembled.

A tool clamping device, in which a plurality of support elements are arranged on the tool spindle and about the rotational axis, provides, by means of the support elements, additional regions for absorbing and introducing machining forces. Since the support elements are arranged on the tool spindle, they can be used both for conventional tools and for heavy tools.

A machine tool for machining workpieces with a base frame, a workpiece receiver arranged on the base frame to receive a workpiece to be machined, and a tool clamping device according to the invention to receive a tool provided for machining, because of the tool clamping device according to the invention, allows machining of large workpieces, such as, for example, transmission housings for wind turbines, with conventional and heavy tools.

A machine tool, in which the tool clamping device and the workpiece receiver can be displaced linearly in at least two and, in particular, in at least three directions relative to one another, and in which the workpiece receiver can be pivoted about a pivot axis, allows flexible machining of large workpieces. In particular, the workpiece can be machined from different sides because of the pivot axis of the workpiece receiver. The workpiece can preferably be rotated through 360° about the pivot axis.

The invention is also based on an object of developing a tool of the generic type in such a way that, despite a high weight, the latter can be reliably clamped in an associated tool clamping device and can be used to machine large workpieces.

This object is achieved by a tool, in which the tool head is rotatably mounted on the tool base body about a tool rotational axis, in which to clamp the tool base body, a first counter-clamping unit is arranged concentrically with respect to the tool rotational axis on the tool base body, said first counter-clamping unit, to rotatably drive the tool head, being coupled thereto and in which a plurality of second counter-clamping units are arranged on the tool base body and about the tool rotational axis to additionally clamp the tool base body. The clamping of the heavy tool takes place, on the one hand, by means of the first counter-clamping unit, which can be connected to the first clamping unit of the tool clamping device according to the invention and, on the other hand, by means of the second counter-clamping units, which can be connected to the second clamping units of the tool clamping device according to the invention. As a result, the machining forces acting during the machining of large workpieces on the heavy tools can be effectively absorbed by the tool clamping device. As the tool base body is received in the tool clamping device in a manner that is non-rotatable about the tool rotational axis, the tool head is rotatably driven relative to the tool base body about the tool rotational axis. For this purpose, the tool head is rotatably mounted on the tool base body and coupled to the first counter-clamping unit, which is also rotatably mounted in the tool base body. By rotatably driving the first counter-clamping unit by means of the first clamping unit of the tool clamping device according to the invention, the tool head is therefore rotatably driven. The tool head may, for example, be configured as a rotary, milling or drilling head. The heavy tool has a weight of more than 50 kg, in particular more than 100 kg and, in particular, more than 150 kg.

A tool, in which the counter-clamping units are configured and arranged in such a way that they can be connected to the clamping units of the tool clamping device according to the invention, ensures that the tool according to the invention can be connected to the tool clamping device according to the invention. For connectability, the first counter-clamping unit has to be arranged and configured in accordance with the first clamping unit and the second counter-clamping units have to be arranged and configured in accordance with the second clamping units. In the clamped state of the heavy tool, the rotational axis of the tool clamping device coincides with the tool rotational axis. Accordingly, the features of the tool claiming device, in which at least three second clamping units and, in particular, at least four second clamping units are arranged on the base body, in which the second clamping units are arranged in the form of a polygon, in particular in the form of a rectangle, about the rotational axis, in which the second clamping units are stationary relative to the base body, an in which the second clamping units are axially offset with respect to the first clamping unit, apply in a corresponding manner to the second counter-clamping units in relation to the tool rotational axis and the tool base body. Furthermore, the tool according to the invention, in which a coolant connection is arranged laterally next to the tool spindle on the base body, the coolant connection in particular being integrated in the housing, in which an electrical connection is arranged laterally next to the tool spindle on the base body, the electrical connection in particular being integrated in the housing, in which an identification element for tool identification is arranged laterally next to the tool spindle on the base body, the identification element in particular being integrated in the housing, an in which a plurality of support elements are arranged on the tool spindle and about the rotational axis, may have a coolant counter-connection, an electrical counter-connection, an identification counter-element and support receivers for the support elements of the tool spindle. The coolant counter-connection, the electrical counter-connection, the identification counter-element and the support receivers have to be configured and arranged in such a way that they can be connected, or functionally connected, to the coolant connection, the electrical connection, the identification element and the support elements. With regard to the advantages resulting from this, reference is made to the corresponding advantages already described of the tool clamping device according to the invention.

Further features, advantages and details of the invention emerge from the following description of an embodiment.

### BRIEF DESCRIPTION OF THE DRAWINGS

FIG. 1 shows a perspective view of a machine tool for machining large workpieces with a tool clamping device for conventional and heavy tools.

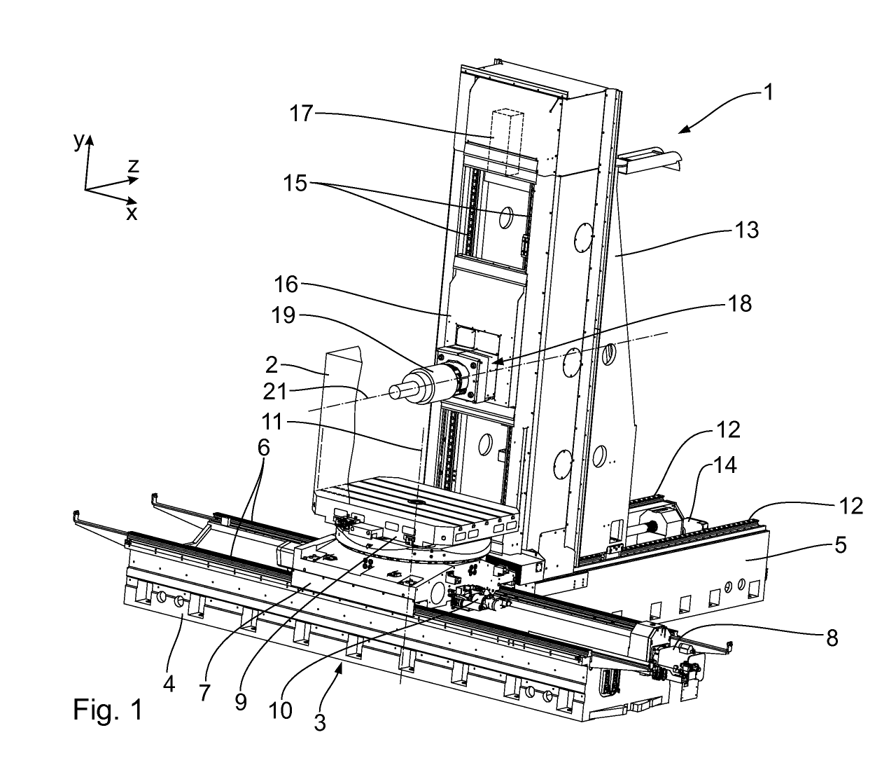

FIG. 2 shows a perspective view of the tool clamping device in FIG. 1.

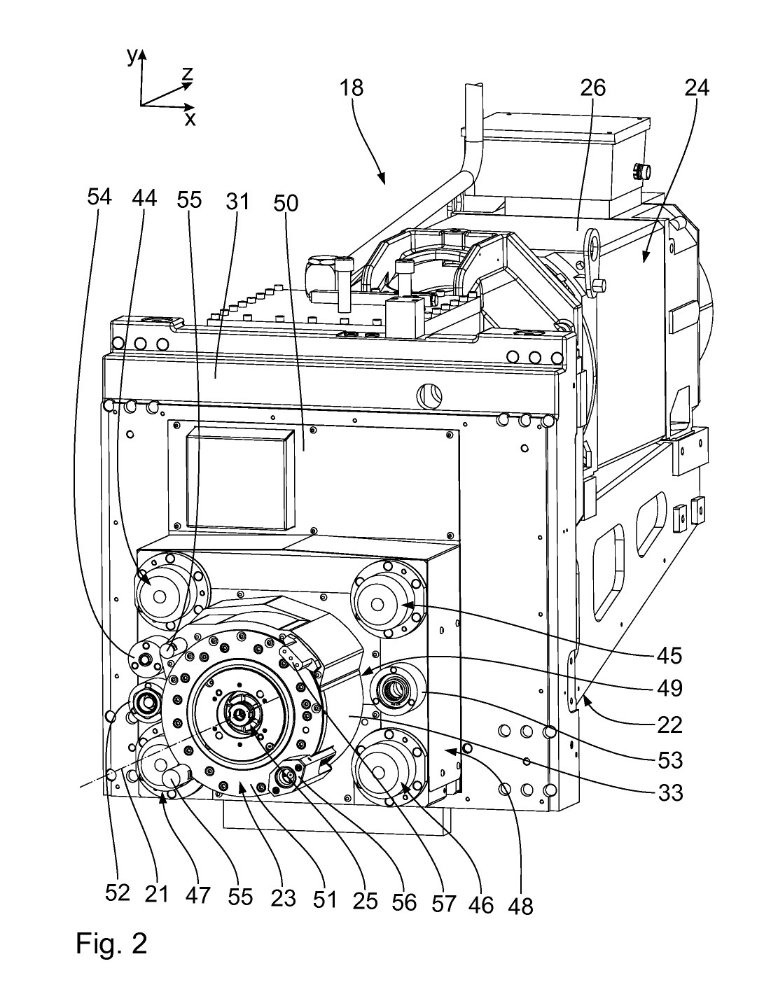

FIG. 3 shows an axial section through the tool clamping device in FIG. 1 with a clamped conventional tool.

FIG. 4 shows a first perspective rear view of a heavy tool for clamping in the tool clamping device according to FIG. 2.

FIG. 5 shows a second perspective rear view of the heavy tool for clamping in the tool clamping device according to FIG. 2.

FIG. 6 shows an axial section through a heavy tool clamped in the tool clamping device in the region of a first clamping unit.

FIG. 7 shows a section through the heavy tool clamped in the tool clamping device in the region of a second clamping unit.

### DESCRIPTION OF THE PREFERRED EMBODIMENT

A machine tool 1, to machine large workpieces 2, such as, for example, trans-mission housings for wind turbines, has a base frame 3, which is T-shaped, and a first frame portion 4 running in a horizontal x-direction and a second frame portion 5 running perpendicular thereto in a horizontal z-direction. Fastened to the first frame portion 4 are two x-guide rails 6 running in the x-direction, on which an x-slide 7 is arranged so as to be linearly displaceable in the x-direction by means of an x-drive motor 8. Arranged on the x-slide 7 is a workpiece receiver 9, which can be pivoted through 360° by means of a drive motor 10 about a pivot axis 11 running parallel to a vertical y-direction. The workpiece receiver 9 is configured as a rotary table, on which a workpiece palette can be exchangeably fixed. A workpiece 2 to be machined can be fastened to the workpiece receiver 9. The x-, y- and z-directions in each case run parallel to one another and form a Cartesian coordinate system.

Fastened to the second frame portion 5 are two z-guide rails 12 running in the z-direction, on which a stand-like z-slide 13 is arranged so as to be linearly movable by means of a z-drive motor 14 in the z-direction. Fastened to the z-slide 13 are in turn two y-guide rails 15 running in the y-direction, on which a y-slide 16 is mounted so as to be linearly displaceable in the y-direction by means of a y-drive motor 17.

Fastened horizontally on the y-slide 16 is a tool clamping device 18, which is used both for clamping conventional tools 19 and for clamping heavy tools 20. The tools 19, can be rotatably driven by means of the tool clamping device 18 about a rotational axis 21 running parallel to the z-direction.

The tool clamping device 18 and the workpiece receiver 9 can therefore be displaced linearly with respect to one another in three directions. In addition, the workpiece receiver 9 can be pivoted about the pivot axis 11 relative to the tool clamping device 18.

The tool clamping device 18 has a housing-like base body 22, on which a conventional and known tool spindle 23 is arranged. The tool spindle 23 comprises a drive unit 24 and a first clamping unit 25 coupled thereto for clamping and rotatably driving a conventional tool 19. The drive unit 24 has an electrical drive motor 26, by means of which a rotary sleeve 29 can be rotatably driven about the rotational axis 21 by means of a gear shaft 27 and a gear 28. The gear shaft 27 and the gear 28 are rotatably mounted by means of bearings 30 in a first base body portion 31, whereas the rotary sleeve 29 is rotatably mounted by means of bearings 32 in the first base body portion 31 and a second base body portion 33. The second base body portion 33 is hollow cylindrical and forms the spindle tube. The second base body portion 33 is accordingly called a spindle tube below.

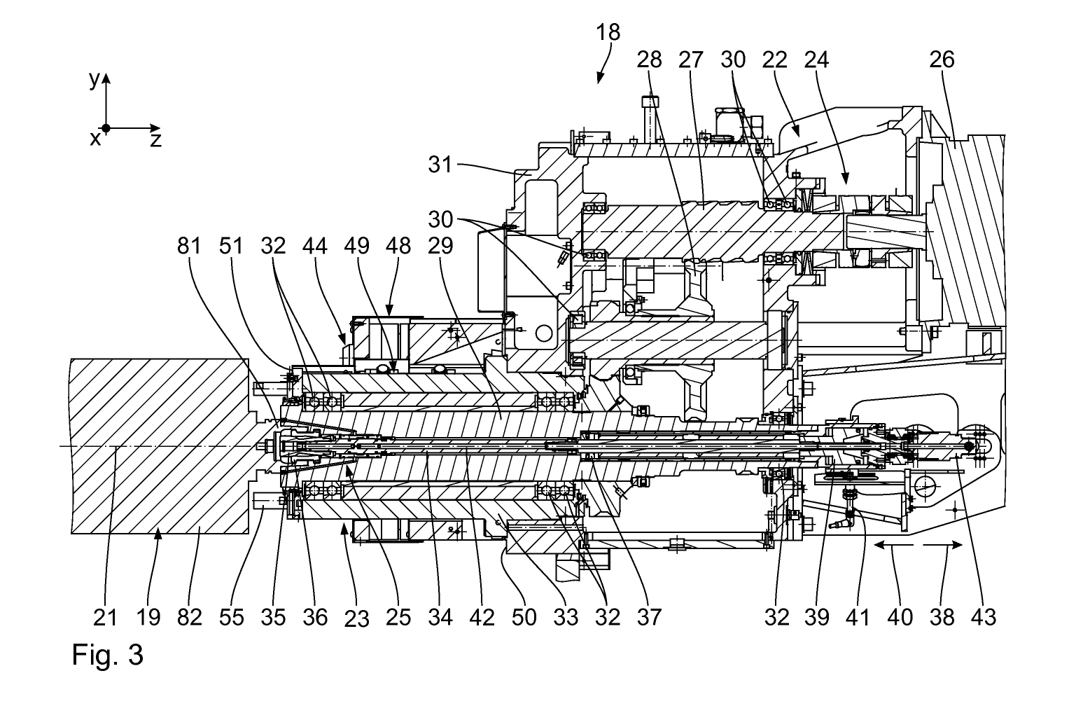

The first clamping unit 25 is integrated in the conventional manner in the rotary sleeve 29 and thus coupled to the drive unit 24. The clamping unit 25, in the conventional manner, has an actuating rod 34, which is mounted concentrically with respect to the rotational axis 21 in the rotary tube 29 and can be axially displaced relative thereto. The actuating rod 34 is coupled at its end facing the respective tool 19, 20 to a clamping cone 35 and associated clamping elements 36, by means of which the respective tool 19, 20 can be clamped and released. To clamp a tool 19, 20, the actuating rod 34 is prestressed relative to the rotary sleeve 29 by means of spring elements 37 in a clamping direction 38. The spring elements 37 are only indicated in FIG. 3. To release the tool 19, 20, the actuating rod 34 is furthermore coupled to a piston-cylinder unit 39, by means of which the actuating rod 34 is axially displaceable in a release direction 40. The axial position of the actuating rod 34 is monitored by means of a position switch 41. A coolant channel 42, by means of which coolant can be supplied by a rotary feed 43 to the respective tool 19, 20, is furthermore configured in the actuating rod 34.

To clamp heavy tools 20, the tool clamping device 18 furthermore has four second clamping units 44 to 47, which are integrated in a housing 48 fastened to the base body 22. The housing 48 is box-like and has a central through-opening 49 for the spindle tube 33. The housing 48 is fastened to an end face 50 of the first base body portion facing the spindle tube 33, the spindle tube 33 being guided through the through-opening 49. The second clamping units 44 to 47 are arranged about the rotational axis 21 and axially displaced relative to an end face 51 of the spindle tube 33. While the first clamping unit 25 can be rotatably driven about the rotational axis 21, the second clamping units 44 to 47 are stationary relative to the base body 22, in other words cannot be rotated about the rotational axis 21. The second clamping units 44 to 47 are arranged in a polygonal or rectangular or square manner about the rotational axis 21.

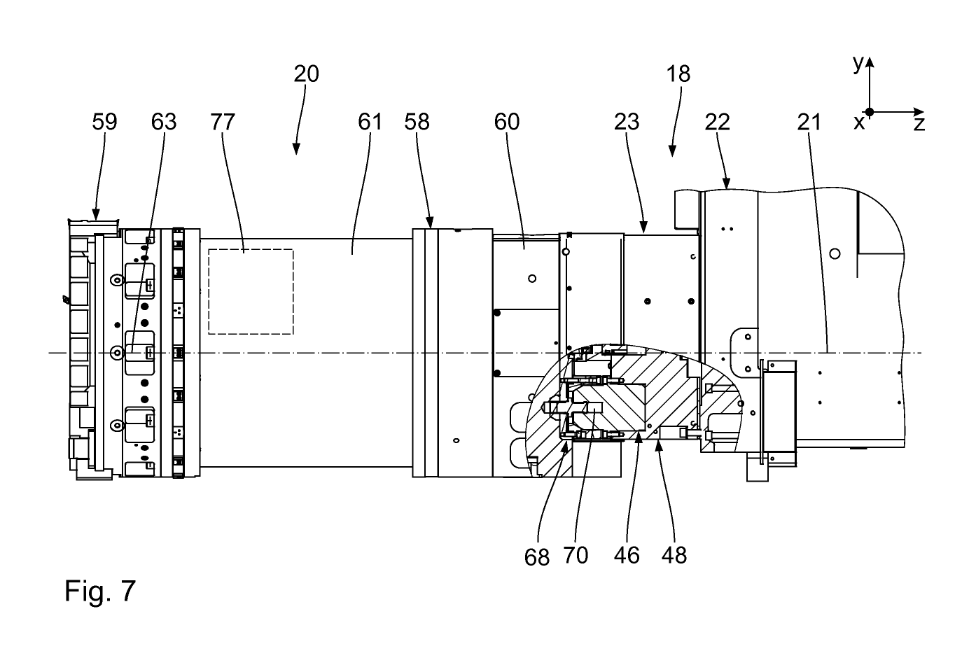

The second clamping units 44 to 47 have a conventional clamping mechanism, which, for example, can be actuated electromechanically, hydraulically or pneumatically. The clamping mechanism corresponds, for example, to the already described clamping mechanism of the first clamping unit 25. Alternatively, a sleeve-like clamping cone can be axially displaced by means of a double-acting piston-cylinder unit, said clamping cone cooperating, upon an axial displacement, with clamping elements, which clamp and release the respective tool 20 depending on the displacement direction. This is indicated in FIG. 7.

The clamping units may also be self-locking. Clamping units of this type are known.

Also arranged on the base body 22 are a separate coolant connection 52, a separate electrical connection 53 and an identification element 54, laterally next to the spindle tube 33, which are also integrated in the housing 48. The coolant connection 52 is used to supply the heavy tools 20 with coolant. In addition, the electrical connection 53 is used to supply the heavy tools 20 with electrical energy. The identification element is used for automatic tool identification of the heavy tools 20.

To support the tool, a plurality of support elements 55, 56, 57 are furthermore arranged on the end face 51 of the tool spindle 23 or the spindle tube 33 about the rotational axis 21. The support elements 55 are only used for tool support, whereas the support elements 56 and 57 realize additional functionalities, such as, for example, safeguarding against rotation or a position control to ensure correct positioning of the tools 19 or 20.

In addition to conventional tools 19, so-called heavy tools 20 are also provided to machine the workpiece 2. Tools having a weight of more than 50 kg, in particular more than 100 kg and, in particular, more than 150 kg, are called a heavy tool 20.

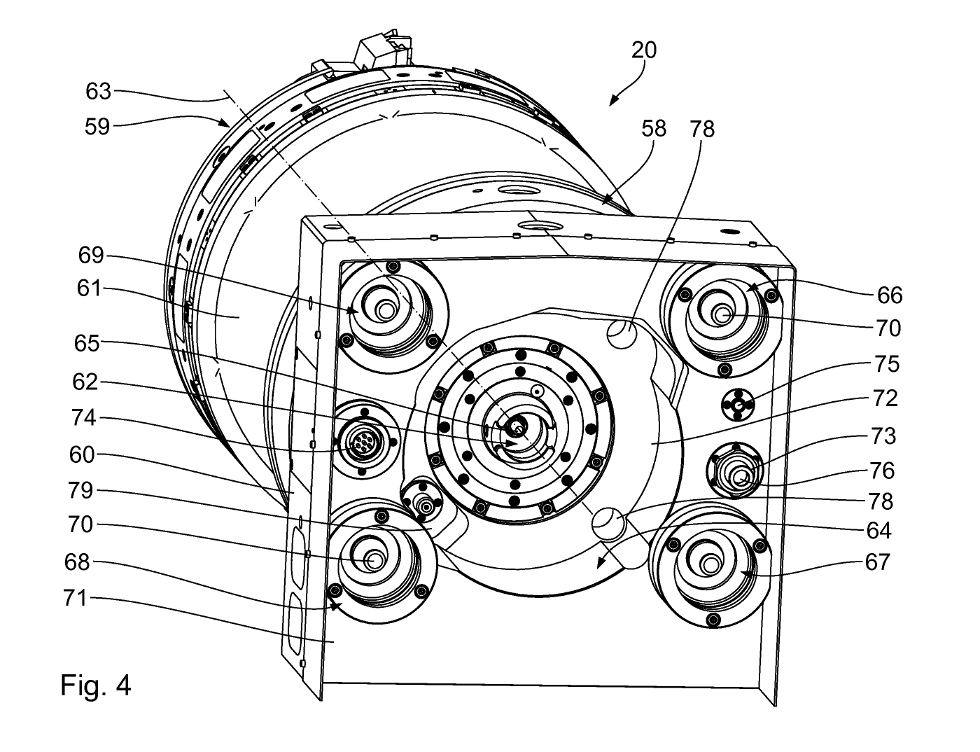

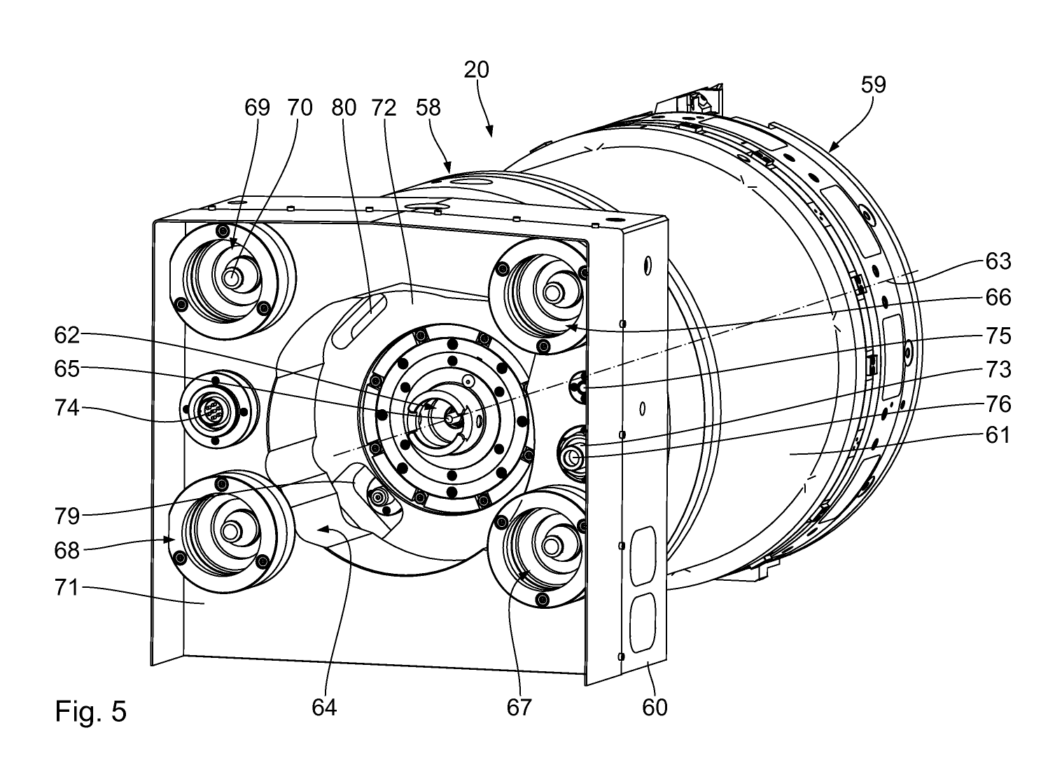

FIGS. 4 to 7 show a heavy tool 20. The heavy tool 20 has a tool base body 58, on which a tool head 59 is arranged to machine the workpiece 2. The tool base body 58 has a plate-shaped first base body portion 60 and a hollow cylindrical second base body portion 61 extending from the latter. A first counter-clamping unit 62 is rotatably mounted about a tool rotational axis 63 in the second base body portion 61. The counter-clamping unit 62 is mechanically coupled to the tool head 59, which is also rotatably mounted on the second base body portion 61 and can be rotatably driven by means of the first counter-clamping unit 62.

The first base body portion 60, in the region of the first counter-clamping unit 62, has a recess 64 for the spindle tube 33, so that the counter-clamping unit 62 is freely accessible to the clamping unit 25. The counter-clamping unit 62 is configured and arranged in such a way that it can be connected to the clamping unit 25 of the tool clamping device 18 and released again. To supply coolant to the tool head 59, a first coolant channel 65 is arranged concentrically with respect to the tool rotational axis 63. The coolant channel 65 can be connected to the coolant channel 42.

Four second counter-clamping units 66 to 69, which are configured and arranged such that they can be connected to the second clamping units 44 to 47 of the tool clamping device 18 and can be released again, are fastened to the first base body portion 60. For this purpose, the counter-clamping units 66 to 69 in each case have a pin-like clamping element 70, which can be clamped in the associated second clamping unit 44 to 47. The second counter-clamping units 66 to 69 are arranged on an end face 71 of the first base body portion 60 remote from the tool head 59. In comparison, the first counter-clamping unit 62 is arranged on an end face 72, arranged offset with respect thereto, of the second base body portion 61.

Furthermore arranged on the end face 71 are a coolant counter-connection 73, an electrical counter-connection 74 and an identification counter-element 75 such that the latter can be connected, or functionally connected, to the coolant connection 52, the electrical connection 53 and the identification element 54. Proceeding from the coolant counter-connection 73, a second coolant channel 76 runs to the tool head 59. The electrical counter-connection 74 is connected to a merely indicated drive motor 77, which, for example, allows an additional adjustment possibility for the tool head 59.

Support recesses 78, 79, 80 are configured and arranged on the end face 72 in such a way that the support elements 55, 56, 57 can be received therein to support the tool 20.

FIG. 3 shows the tool clamping device 18 according to the invention with a conventional tool 19 having a counter-clamping unit 81 and a tool head 82 arranged thereon. The tool 19 is clamped in a conventional manner by means of the first clamping unit 25. The tool 19 is rotatably driven by means of the drive unit 24 to machine the workpiece 2. The tool 19, during the machining of the workpiece 2, is moved—as required—in the linear direction and the workpiece 2 is rotated about the pivot axis 11. To change the tool 19, a tool magazine, not shown in more detail, is arranged with a tool changer laterally next to the machine tool 1. The tool 19 is released by means of the piston-cylinder unit 39 in such a way that the actuating rod 34 is axially displaced in the release direction 40, with the clamping elements 36 releasing the tool 19.

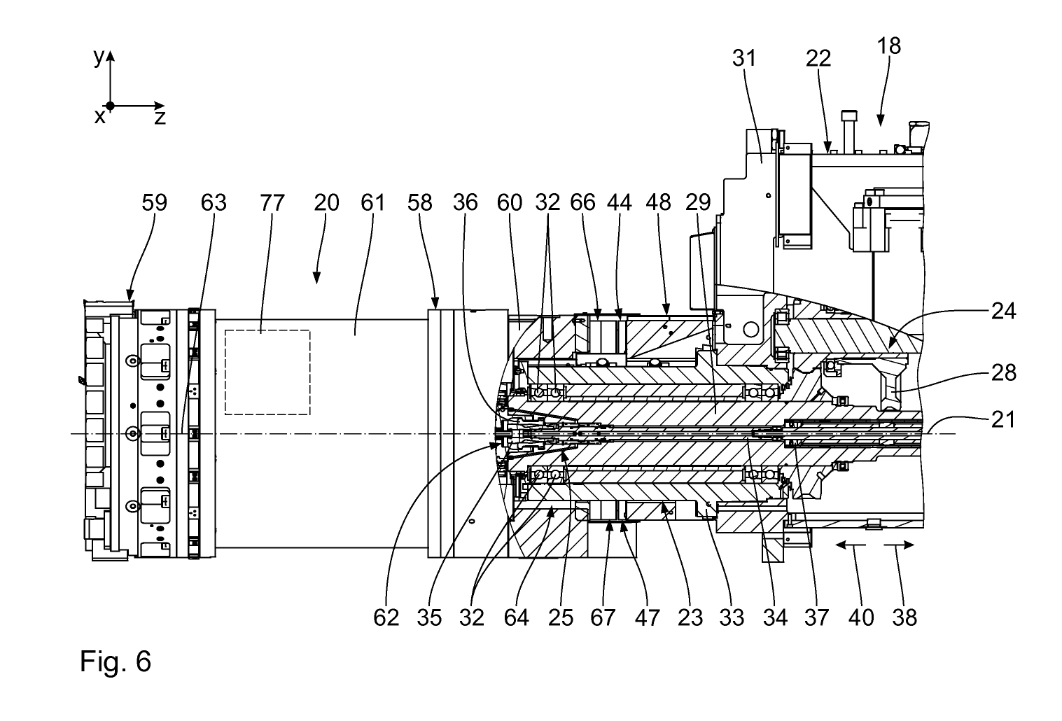

FIGS. 6 and 7 show the tool clamping device 18 according to the invention with a clamped heavy tool 20. The first counter-clamping unit 62 is clamped by means of the first clamping unit 25. In addition, the second counter-clamping units 66 to 69 are clamped by means of the associated second clamping units 44 to 47. This is shown by way of example for the counter-clamping unit 68 and the associated clamping unit 46 in FIG. 7. Since the heavy tool 20 is clamped by a total of five clamping units 25, 44 to 47 in the tool clamping device 18, machining forces occurring during the machining of the workpiece 2 can be effectively absorbed by the tool clamping device 18.

To machine the workpiece 2, the tool head 59 is rotatably driven by means of the drive unit 24 by means of the clamping unit 25 and the associated counter-clamping unit 62 about the rotational axis 21 or the tool rotational axis 63. The actuating rod 34 is loaded by means of the spring elements 37 in the clamping direction 38 with a clamping force, so the clamping elements 36 hold the counter-clamping unit 62 in the conventional manner. The support elements 55 to 57 are arranged, in the clamped state of the heavy tool 20, in the associated support recesses 78 to 80 and additionally support the tool 20. The tool 20 may, for example, be configured as a facing head, angle turning head or angle drilling head.

What is claimed is:

1. A tool clamping device comprising:
a base body;
tool spindle arranged on the base body to rotatably drive a tool, the tool spindle comprising a first clamping unit to clamp the tool, and a drive unit coupled to the first clamping unit to rotatably drive the first clamping unit about a rotational axis; and,
a plurality of second clamping units arranged on the base body and about the rotational axis of the tool spindle to additionally clamp the tool.

2. A tool clamping device according to claim 1 further comprising:
at least three second clamping units arranged on the base body.

3. A tool clamping device according to claim 1 further comprising:
at least four second clamping units arranged on the base body.

4. A tool clamping device according to claim 1,
wherein the second clamping units are arranged in the form of a polygon about the rotational axis.

5. A tool clamping device according to claim 1,
wherein the second clamping units are arranged in the form of a rectangle about the rotational axis.

6. A tool clamping device according to claim 1,
wherein the second clamping units are stationary relative to the base body.

7. A tool clamping device according to claim 1,
wherein the second clamping units are axially offset with respect to the first clamping unit.

8. A tool clamping device according to claim 1 further comprising:
a housing fastened to the base body and having a through-opening for the tool spindle, wherein the second clamping units are integrated in the housing.

9. A tool clamping device according to claim 1 further comprising:
a coolant connection arranged laterally next to the tool spindle on the base body.

10. A tool clamping device according to claim 9 further comprising:
a housing fastened to the base body and having a through-opening for the tool spindle, wherein the coolant connection is integrated in the housing.

11. A tool clamping device according to claim 1 further comprising:
an electrical connection arranged laterally next to the tool spindle on the base body.

12. A tool clamping device according to claim 11 further comprising:
a housing fastened to the base body and having a through-opening for the tool spindle, wherein the electrical connection is integrated in the housing.

13. A tool clamping device according to claim 1 further comprising:
an identification element for tool identification arranged laterally next to the tool spindle on the base body.

14. A tool clamping device according to claim 13 further comprising:
a housing fastened to the base body and having a through-opening for the tool spindle, wherein the identification element is integrated in the housing.

15. A tool clamping device according to claim 1 further comprising:
a plurality of support elements arranged on the tool spindle and about the rotational axis.

16. A machine tool for machining workpieces comprising a base frame, a workpiece receiver arranged on the base frame to receive a workpiece to be machined, and a tool clamping device to receive a tool provided for machining, the device comprising;
a base body;
a tool spindle arranged on the base body to rotatably drive a tool, the tool spindle comprising a first clamping unit to clamp the tool and a drive unit coupled to the first clamping unit to rotatably drive the first clamping unit about a rotational axis; and,
a plurality of second clamping units arranged on the base body and about the rotational axis of the tool spindle to additionally clamp the tool.

17. A machine tool according to claim 16,
wherein the tool clamping device and the workpiece receiver are linearly displaceable in at least two directions relative to one another.

18. A machine tool according to claim 16,
wherein the tool clamping device and the workpiece receiver are linearly displaceable in at least three directions relative to one another.

19. A machine tool according to claim 16,
wherein the workpiece receiver is pivotable about a pivot axis.

20. A tool to be received in a tool clamping device, the tool comprising:
a tool base body;
a tool head arranged on the tool base body to machine a workpiece, wherein the tool head is rotatably mounted on the tool base body about a tool rotational axis;
a first counter-clamping unit arranged concentrically with respect to the tool rotational axis on the tool base body to clamp the tool base body, said first counter-clamping unit being coupled thereto to rotatably drive the tool head; and,
a plurality of second counter-clamping units arranged on the tool base body and about the tool rotational axis to additionally clamp the tool base body.

21. A tool according to claim 20,
wherein the counter-clamping units are configured and arranged in such a way that they are connectable to corresponding clamping units of the tool clamping device.
